(19) United States
(12) Patent Application Publication
(10) Pub. No.: US 2023/0178989 A1
(43) Pub. Date: Jun. 8, 2023

(54) Current Control Method and System for Voltage Asymmetry Fault

(71) Applicant: Huawei Digital Power Technologies Co., Ltd., Shenzhen (CN)

(72) Inventors: Zhangping Shao, Shanghai (CN); Kai Xin, Shanghai (CN); Haibin Guo, Dongguan (CN)

(21) Appl. No.: 18/151,987

(22) Filed: Jan. 9, 2023

Related U.S. Application Data
(63) Continuation of application No. PCT/CN2020/104454, filed on Jul. 24, 2020.

(51) Int. Cl. H02J 3/18; H02M 7/66; H02J 3/00; G05B 19/042

(52) U.S. Cl. CPC H02J 3/18; G05B 19/042; H02J 3/001; H02M 7/66; G05B 2219/2639

(57) ABSTRACT

A current control method and system for a voltage asymmetry fault is disclosed. When a voltage asymmetry fault occurs, a first current limit value is obtained based on a post-fault positive-sequence voltage and a pre-fault positive-sequence reactive current, and a second current limit value is obtained based on a post-fault negative-sequence voltage and a pre-fault negative-sequence voltage. A third current limit value and a fourth current limit value are obtained based on the first current limit value and the second current limit value. A magnitude of a positive-sequence reactive current is limited by using the third current limit value, and a magnitude of a negative-sequence reactive current is limited by using the fourth current limit value.

### CROSS-REFERENCE TO RELATED APPLICATIONS

This application is a continuation of International Application No. PCT/CN2020/104454, filed on Jul. 24, 2020, the disclosure of which is hereby incorporated by reference in its entirety.

### TECHNICAL FIELD

This application relates to the field of electric and electronic technologies, and in particular, to a current control method and system for a voltage asymmetry fault.

### BACKGROUND

When a single-phase or two-phase fault occurs on a transmission line of a power grid, a voltage asymmetry fault such as a high voltage asymmetry fault or a low voltage asymmetry fault occurs on the power grid. To reduce impact of the asymmetry fault, a converter operates on the grid, and injects a positive-sequence reactive current and a negative-sequence reactive current into the power grid.

However, the negative-sequence reactive current causes three-phase current imbalance for the converter, thereby easily causing an overcurrent problem for the converter.

To resolve the foregoing problem, the converter is controlled, based on a given initial value of the positive-sequence reactive current and a given initial value of the negative-sequence reactive current, to output three-phase currents. When it is detected that one of the output three-phase currents exceeds an allowed value, the injected positive-sequence reactive current and negative-sequence reactive current are adjusted. The converter is controlled, by using an adjusted positive-sequence reactive current and negative-sequence reactive current, to output three-phase currents again, until all output three-phase currents meet a requirement.

In the foregoing solution, to obtain the three-phase currents that meet the requirement, repeated iterations need to be performed to meet the requirement. It takes a relatively long time to obtain a reactive current. The relatively long time cannot meet a requirement for a reactive current adjustment time in an on-grid standard.

### SUMMARY

This application provides a current control method and system for a voltage asymmetry fault, to meet a requirement for a reactive current adjustment time when a voltage asymmetry fault occurs.

This application provides a current control method for a voltage asymmetry fault. When a voltage asymmetry fault occurs, a first current limit value is obtained based on a post-fault positive-sequence voltage and a pre-fault positive-sequence reactive current, and a second current limit value is obtained based on a post-fault negative-sequence voltage and a pre-fault negative-sequence voltage. A third current limit value I₃ and a fourth current limit value I₄ are obtained based on the first current limit value I₁ and the second current limit value I₂, where I₃ is directly proportional to I₁, and I₄ is directly proportional to I₂. A magnitude of a positive-sequence reactive current is limited by using I₃, and a magnitude of a negative-sequence reactive current is limited by using I₄, to prevent the negative-sequence reactive current injected when the voltage asymmetry fault occurs from causing an overcurrent. In the method, a magnitude limit value for the positive-sequence reactive current and a magnitude limit value for the negative-sequence reactive current are obtained at a time, without repeated iterative calculation. A positive-sequence reactive current and a negative-sequence reactive current that meet a requirement are obtained within a relatively short time, thereby shortening a reactive current adjustment time.

A specific manner of determining a voltage asymmetry fault is not limited in this application. For example, whether a voltage asymmetry fault occurs may be determined by using three-phase voltages at a converter port. The three-phase voltages may be three-phase line voltages or three-phase phase voltages.

Whether the three-phase voltages are equal may be determined by using effective values of the three-phase voltages. Specifically, whether effective values of the three-phase phase voltages are equal may be determined, or whether effective values of the three-phase line voltages are equal may be determined. Whether a smallest value of the three-phase voltages is less than a low voltage fault trigger threshold is determined, or whether a largest value of the three-phase voltages is greater than a high voltage fault trigger threshold is determined. If the smallest value of the three-phase voltages is less than the low voltage fault trigger threshold, or the largest value of the three-phase voltages is greater than the high voltage fault trigger threshold, a voltage asymmetry fault occurs.

For example, an application scenario is a three-phase power grid. A converter may be controlled based on a magnitude-limited commanded value of the positive-sequence reactive current and a magnitude-limited commanded value of the negative-sequence reactive current. Specifically, a driving pulse signal for a switch in the converter may be generated based on the magnitude-limited commanded value of the positive-sequence reactive current and the magnitude-limited commanded value of the negative-sequence reactive current, so that a current in the converter is not subject to an overcurrent phenomenon.

This application further provides a method for limiting a magnitude of a positive-sequence active current comprising obtaining a fifth current limit value I₅ based on I₃ and I₄, and limiting the magnitude of the positive-sequence active current by using I₅.

The obtaining I₃ based on I₁ and I₂ specifically includes: when a sum I₁₂ of I₁ and I₂ is less than or equal to a preset current, I₃ is equal to I₁, where the preset current is a rated current of a converter or a maximum current of the converter; or when the sum I₁₂ of I₁ and I₂ is greater than the preset current, obtaining I₃ based on the preset current and a ratio of I₁ to I₁₂.

The obtaining I₄ based on I₁ and I₂ specifically includes, when a sum I₁₂ of I₁ and I₂ is less than or equal to a preset current, I₄ is equal to I₂, where the preset current is a rated current of a converter or a maximum current of the converter; or when the sum I₁₂ of I₁ and I₂ is greater than the preset current, obtaining I₄ based on the preset current and a ratio of I2 to I₁₂.

The obtaining a fifth current limit value I₅ based on I₃ and I₄ specifically includes, obtaining I₅ based on I₃, I₄, and a preset current, where the preset current is a rated current of a converter or a maximum current of the converter.

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}}$$

The obtaining I₃ based on the preset current and a ratio of I₁ to I₁₂ is specifically obtaining I₃ by using the following formula:

$${\text{I}}_{3} = \frac{{\text{I}}_{1} \times {\text{I}}_{\text{LMT}}}{{\text{I}}_{1} + {\text{I}}_{2}} {\text{I}}_{{\text{LMT}}^{,}}$$

where

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}}$$

is the preset current.

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}}$$

The obtaining I₄ based on the preset current and a ratio of I2 to I₁₂ is specifically obtaining I₄ by using the following formula:

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}} ,$$

where

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}}$$

is the preset current.

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3}$$

The obtaining I₅ based on I₃, I₄, and a preset current is specifically obtaining I₅ by using the following formula: [0023]

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3} {\text{I}}_{5} = max ,$$

where

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3}$$

is the preset current, is a preset adjustment coefficient for the positive-sequence active current, and o < K₃ ≤ 1.

I_{LMT} The obtaining a first current limit value I₁ based on I_{Qo} and U₁ is specifically obtaining I₁ by using the following formula:
I_{LMT}I₁ = |I_{Qo} + K₁ × I_{LMT} × (U_{O1} - U₁)/U_{N}|, where
I_{LMT} is the preset current, U_{O1} is the pre-fault positive-sequence voltage, U_{N} is a rated voltage of the converter, K₁ is a preset adjustment coefficient for the positive-sequence reactive current, o < K₁ ≤ ₁₀, and the preset current is the rated current of the converter or the maximum current of the converter.

I_{LMT} The obtaining a first current limit value I₁ based on I_{Qo} and U₁ is specifically obtaining I₁ by using the following formula:
I_{LMT}I₁ = |I_{Qo} + K₁ × I_{LMT} × (U_{TR} - U₁)/U_{N}|, where
I_{LMT} is the preset current, U_{TR} is a preset trigger threshold for a voltage asymmetry fault, U_{N} is a rated voltage of the converter, K₁ is a preset adjustment coefficient for the positive-sequence reactive current, and the preset current is the rated current of the converter or the maximum current of the converter.

I_{LMT} The obtaining a second current limit value I₂ based on U₂ and U_{O2} is specifically obtaining I₂ by using the following formula:
I_{LMT}I₂ = |K₂ × I_{LMT} × (U_{O2} - U₂)/U_{N}|, where
I_{LMT} is the preset current, U_{N} is a rated voltage of the converter, K₂ is a preset adjustment coefficient for the negative-sequence reactive current, o < K₂ ≤ ₁₀, and the preset current is the rated current of the converter or the maximum current of the converter.

The limiting a magnitude of a positive-sequence reactive current by using I₃, and limiting a magnitude of a negative-sequence reactive current by using I₄ is specifically as follows:
   |I_{Q1}*| ≤ I₃, |I_{Q2}*| ≤ I₄, where
I_{Q1}* is a commanded value of the positive-sequence reactive current, and I_{Q2}* is a commanded value of the negative-sequence reactive current.

The limiting a magnitude of a positive-sequence active current by using I₅ is specifically as follows:
   |I_{P1}*| ≤ I₅, where
I_{P}1_{*} is a commanded value of the positive-sequence active current.

This application further provides a converter system, to prevent a negative-sequence reactive current injected when a voltage asymmetry fault occurs from causing an overcurrent. In the method, a magnitude limit value for the positive-sequence reactive current and a magnitude limit value for the negative-sequence reactive current are obtained at a time, without repeated iterative calculation. A positive-sequence reactive current and a negative-sequence reactive current that meet a requirement are obtained within a relatively short time, thereby shortening a reactive current adjustment time. The system includes a converter and a controller. A first side of the converter is used to connect to a direct current, and a second side of the converter is used to connect to a power grid. The converter is configured to convert a direct current into an alternating current and transmit the alternating current to the power grid, or is configured to rectify an alternating current transmitted by the power grid into a direct current. The controller is configured to, when a voltage asymmetry fault occurs, obtain a post-fault positive-sequence voltage U₁, a post-fault negative-sequence voltage U₂, a pre-fault negative-sequence voltage U_{O2}, and a pre-fault positive-sequence reactive current I_{Qo}; obtain a first current limit value I₁ based on I_{Qo} and U₁, and obtain a second current limit value I₂ based on U₂ and U_{O2}; obtain a third current limit value I₃ based on I₁ and I₂, and obtain a fourth current limit value I₄ based on I₁ and I₂; and limit a magnitude of a positive-sequence reactive current by using I₃, and limit a magnitude of a negative-sequence reactive current by using I₄, where I₃ is directly proportional to I₁, and I₄ is directly proportional to I₂.

A specific manner of determining a voltage asymmetry fault is not limited in this application. For example, whether a voltage asymmetry fault occurs may be determined by using three-phase voltages at a converter port. The three-phase voltages may be three-phase line voltages or three-phase phase voltages.

Whether the three-phase voltages are equal may be determined by using effective values of the three-phase voltages. Specifically, whether effective values of the three-phase phase voltages are equal may be determined, or whether effective values of the three-phase line voltages are equal may be determined. Whether a smallest value of the three-phase voltages is less than a low voltage fault trigger threshold is determined, or whether a largest value of the three-phase voltages is greater than a high voltage fault trigger threshold is determined. If the smallest value of the three-phase voltages is less than the low voltage fault trigger threshold, or the largest value of the three-phase voltages is greater than the high voltage fault trigger threshold, a voltage asymmetry fault occurs.

The controller is further configured to obtain a fifth current limit value I₅ based on I₃ and I₄, and limit a magnitude of a positive-sequence active current by using I₅.

The controller is specifically configured to, when a sum I₁₂ of I₁ and I₂ is less than or equal to a preset current, make I₃ be equal to I₁, where the preset current is a rated current of the converter or a maximum current of the converter; or when the sum I₁₂ of I₁ and I₂ is greater than the preset current, obtain I₃ based on the preset current and a ratio of I₁ to I₁₂.

The controller is specifically configured to, when a sum I₁₂ of I₁ and I₂ is less than or equal to a preset current, make I₄ be equal to I₂, where the preset current is a rated current of the converter or a maximum current of the converter; or when the sum I₁₂ of I₁ and I₂ is greater than the preset current, obtain I₄ based on the preset current and a ratio of I₂ to I₁₂.

The controller is specifically configured to obtain I₅ based on I₃, I₄, and a preset current, where the preset current is a rated current of the converter or a maximum current of the converter.

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}}$$

The controller is specifically configured to obtain I₃ by using the following formula:

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}} ,$$

where

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}}$$

is the preset current.

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}}$$

The controller is specifically configured to obtain I₄ by using the following formula:

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}} ,$$

where

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}}$$

is the preset current.

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3}$$

The controller is specifically configured to obtain I₅ by using the following formula:

$$\left[\sqrt{{\left({\text{I}}_{\text{LMT}} - \left|{\text{I}}_{4}\right|\right)}^{2} - {\left|{\text{I}}_{3}\right|}^{2} ,} {\text{K}}_{3} \times {\text{I}}_{\text{LMT}}\right] {\text{I}}_{\text{LMT}} {\text{K}}_{3} {\text{I}}_{5} = max ,$$

where

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3}$$

is the preset current, is a preset adjustment coefficient for the positive-sequence active current, and o < K₃ ≤ 1.

The controller is specifically configured to limit the magnitude of the positive-sequence reactive current and limit the magnitude of the negative-sequence reactive current in the following manner:
   |I_{Q1}*| ≤ I₃, |I_{Q2}*| ≤ I₄, where
I_{Q1}* is a commanded value of the positive-sequence reactive current, and I_{Q2}* is a commanded value of the negative-sequence reactive current.

The controller is specifically configured to limit the magnitude of the positive-sequence active current in the following manner:
   |I_{P1}*| ≤ I₅, where
I_{P1}* is a commanded value of the positive-sequence active current.

According to the foregoing technical solutions, it can be learned that the embodiments of this application have the following advantages.

When a voltage asymmetry fault occurs, a first current limit value is obtained based on a post-fault positive-sequence voltage and a pre-fault positive-sequence reactive current, and a second current limit value is obtained based on a post-fault negative-sequence voltage and a pre-fault negative-sequence voltage. A third current limit value and a fourth current limit value are obtained based on the first current limit value and the second current limit value. A magnitude limit value for a positive-sequence reactive current, namely, the third current limit value, and a magnitude limit value for a negative-sequence reactive current, namely, the fourth current limit value, are directly obtained based on a parameter obtained at a converter port. After the third current limit value and the fourth current limit value are obtained, a magnitude of a positive-sequence reactive current is limited by using the third current limit value, and a magnitude of the negative-sequence reactive current is limited by using the fourth current limit value, so that the positive-sequence reactive current does not exceed the third current limit value, and the negative-sequence reactive current does not exceed the fourth current limit value, thereby preventing the negative-sequence reactive current injected when the voltage asymmetry fault occurs from causing an overcurrent.

In the current control method, a magnitude limit value for the positive-sequence reactive current and a magnitude limit value for the negative-sequence reactive current may be directly obtained at a time, without repeated iterative calculation. A positive-sequence reactive current and a negative-sequence reactive current that meet a requirement are obtained within a relatively short time, so that a reactive current adjustment time can be shortened. In the technical solutions provided in this application, when a voltage asymmetry fault occurs, a positive-sequence reactive current and a negative-sequence reactive current that meet a requirement may be injected into a power grid while a time requirement is met, to resolve a problem that a negative-sequence reactive current causes an overcurrent for a converter.

### BRIEF DESCRIPTION OF THE DRAWINGS

FIG. 1 is a schematic diagram of power transmission and transformation according to an embodiment of this application;

FIG. 2 is a schematic diagram of unbalanced currents according to an embodiment of this application;

FIG. 3 is a flowchart of a current control method according to an embodiment of this application;

FIG. 4 is a flowchart of determining a voltage asymmetry fault according to an embodiment of this application;

FIG. 5 is a flowchart of a method for obtaining I₃ according to an embodiment of this application;

FIG. 6 is a flowchart of a method for obtaining I₄ according to an embodiment of this application;

FIG. 7A is an effect diagram of reactive current adjustment in a conventional technology;

FIG. 7B is an effect diagram of reactive current adjustment according to an embodiment of this application;

FIG. 8 is a flowchart of another current control method according to an embodiment of this application; and

FIG. 9 is a schematic diagram of a converter system according to an embodiment of this application.

### DETAILED DESCRIPTION OF ILLUSTRATIVE EMBODIMENTS

To enable persons skilled in the art to better understand and implement the technical solutions provided in the embodiments of this application, the following describes in detail application scenarios of the technical solutions with reference to the accompanying drawings.

FIG. 1 is a schematic diagram of power transmission and transformation according to an embodiment of this application.

A converter 103 may convert a direct current into an alternating current and transmit the alternating current to a transformer 102. The converter 103 may be an inverter. A source of a direct current at an input end of the converter may be a direct current power source, for example, a direct current provided by a photovoltaic power generating system.

The transformer 102 is configured to perform voltage transformation on the alternating current transmitted by the converter 103, and then transmit the alternating current to a power grid 101 through a transmission line. The power grid 101 herein is an alternating current power grid.

Alternatively, the converter 103 may be a rectifier. To be specific, an alternating current transmitted by the transformer 102 from the power grid 101 is rectified into a direct current. This is not limited in the embodiments of this application. The converter 103 may be a bidirectional converter, and may serve as a rectifier or an inverter in different scenarios.

In an actual operating process, an operating environment is relatively harsh, and an actual scenario is relatively complex. Therefore, a voltage asymmetry fault, such as a single-phase fault or a two-phase fault, is likely to occur on the transmission line. In this case, a positive-sequence reactive current and a negative-sequence reactive current may be injected into the power grid 101 while ensuring that the converter 103 is on the grid. However, the negative-sequence reactive current is likely to cause three-phase current imbalance for the converter 103.

To resolve an overcurrent problem of a current and meet a requirement of a power grid for a reactive current adjustment time, the following describes specific methods provided in the embodiments of this application.

### Method Embodiment 1

When a voltage asymmetry fault occurs on a power grid, to help the power grid with asymmetry recovery, a converter injects a positive-sequence reactive current and a negative-sequence reactive current into the power grid. However, the negative-sequence reactive current causes three-phase current imbalance for the converter. The following describes a cause of current imbalance with reference to the accompanying drawings.

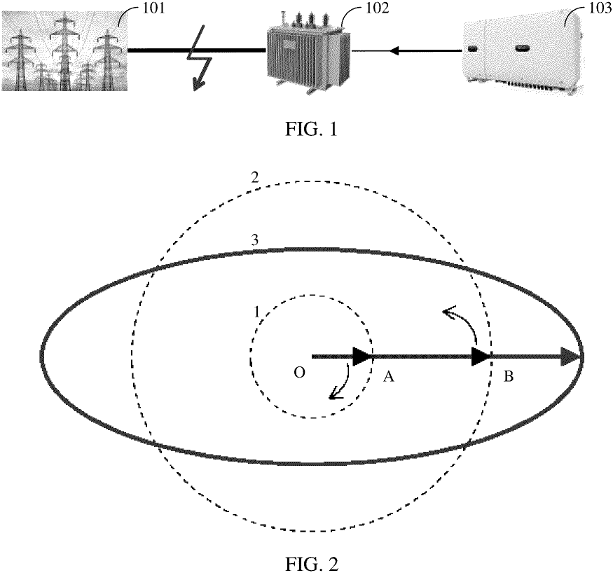

FIG. 2 is a schematic diagram of unbalanced currents according to an embodiment of this application.

Both a positive-sequence current and a negative-sequence current have circular tracks.

A dashed-line circle 1 is a track of a negative-sequence reactive current. A dashed-line circle 2 is a track of a positive-sequence reactive current. A solid-line ellipse 3 is a track of an actual current.

The dashed-line circle 1 is a track formed through clockwise rotation by using a circle center O as a circle center and a negative-sequence reactive current OA as a radius.

The dashed-line circle 2 is a track formed through counterclockwise rotation by using the circle center O as a circle center and a positive-sequence reactive current OB as a radius.

A preset current is a rated current of a converter or a maximum current of a converter. When a sum of the negative -sequence reactive current OA and the positive-sequence reactive current OB exceeds the preset current, an overcurrent may have occurred.

As shown in the figure, when the negative-sequence reactive current OA and the positive-sequence reactive current OB are in a same direction, the sum of the negative-sequence reactive current OA and the positive-sequence reactive current OB exceeds the preset current. This may cause an overcurrent problem for the converter.

To meet a requirement for a reactive current adjustment time and resolve an overcurrent problem for a converter, the embodiments of this application provide a current control method for a voltage asymmetry fault. In the method, when a voltage asymmetry fault occurs, a magnitude limit value for a negative-sequence reactive current and a magnitude limit value for a positive-sequence reactive current are directly obtained by using a parameter obtained at a converter port. Then a magnitude of the negative-sequence reactive current is limited by using the magnitude limit value for the negative-sequence reactive current, and a magnitude of a positive-sequence reactive current is limited by using the magnitude limit value for the positive-sequence reactive current. In the method, the magnitude limit value for the positive-sequence reactive current and the magnitude limit value for the negative-sequence reactive current may be directly obtained at a time, without repeated iterative calculation, so that a reactive current adjustment time can be shortened. When a voltage asymmetry fault occurs on a power grid, a requirement for a reactive current adjustment time in an on-grid standard can be met, and an overcurrent problem can also be resolved for a converter.

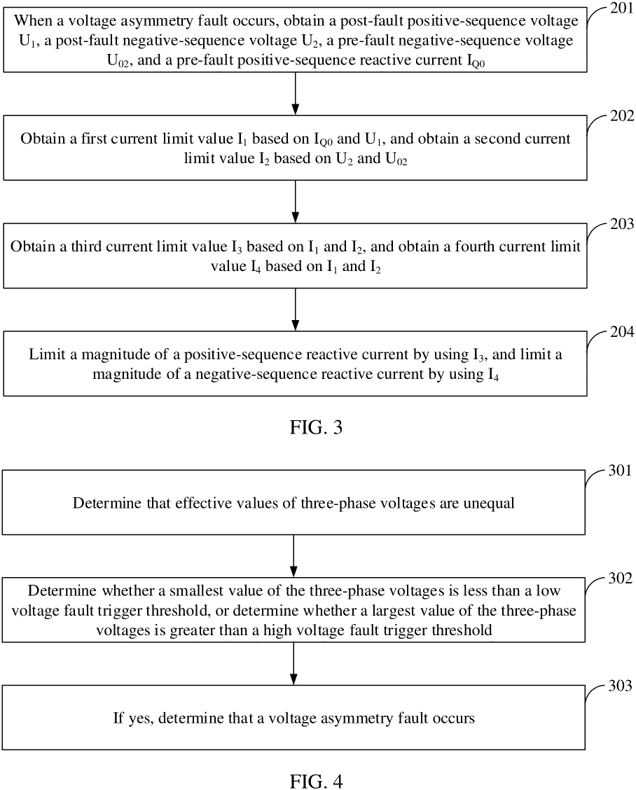

FIG. 3 is a flowchart of a current control method according to an embodiment of this application.

The current control method provided in this embodiment of this application includes the following steps.

Step 201: When a voltage asymmetry fault occurs, obtain a post-fault positive-sequence voltage U₁, a post-fault negative-sequence voltage U₂, a pre-fault negative-sequence voltage U_{O2}, and a pre-fault positive-sequence reactive current I_{Qo}.

A specific manner of determining a voltage asymmetry fault is not limited in this application. For example, whether a voltage asymmetry fault occurs may be determined by using three-phase voltages at a converter port. The three-phase voltages may be three-phase line voltages or three-phase phase voltages.

FIG. 4 is a flowchart of determining a voltage asymmetry fault according to an embodiment of this application.

The procedure includes the following steps.

Step 301: Determine that the three-phase voltages are unequal.

For example, whether the three-phase voltages are equal may be determined by using effective values of the three-phase voltages.

Specifically, whether effective values of the three-phase phase voltages are equal may be determined, or whether effective values of the three-phase line voltages are equal may be determined.

Step 302: Determine whether a smallest value of the three-phase voltages is less than a low voltage fault trigger threshold, or determine whether a largest value of the three-phase voltages is greater than a high voltage fault trigger threshold.

If it is determined, by using the three-phase phase voltages, that the effective values of the three-phase voltages are unequal, the three-phase phase voltages are used in all subsequent processes of determining a voltage asymmetry fault. If it is determined, by using the three-phase line voltages, that the effective values of the three-phase voltages are unequal, the three-phase line voltages are used in all subsequent processes of determining a voltage asymmetry fault.

The three-phase phase voltages are used as an example for detailed description below.

If it is determined, by using the three-phase phase voltages, that the effective values of the three-phase voltages are unequal, when whether the smallest value of the three-phase voltages is less than the low voltage fault trigger threshold is determined, a smallest value of the three-phase phase voltages is compared with the low voltage fault trigger threshold; or when whether the largest value of the three-phase voltages is greater than the high voltage fault trigger threshold is determined, a largest value of the three-phase phase voltages is compared with the high voltage fault trigger threshold. Similarly, a principle of determining, by using the three-phase line voltages, whether an asymmetry fault occurs is the same as that of determining, by using the three-phase phase voltages, whether an asymmetry fault occurs, except that fault trigger thresholds corresponding to the two cases are different. Details are not described herein again.

Step 303: If the smallest value of the three-phase voltages is less than the low voltage fault trigger threshold, or the largest value of the three-phase voltages is greater than the high voltage fault trigger threshold, determine that a voltage asymmetry fault occurs.

When the smallest value of the three-phase voltages is less than the low voltage fault trigger threshold, or the largest value of the three-phase voltages is greater than the high voltage fault trigger threshold, the voltage asymmetry fault occurs.

After the voltage asymmetry fault occurs, to obtain a negative-sequence reactive current and a positive-sequence reactive current that meet a requirement, a magnitude limit value for a negative-sequence reactive current and a magnitude limit value for a positive-sequence reactive current need to be obtained by using the post-fault positive-sequence voltage U₁, the post-fault negative-sequence voltage U₂, the pre-fault negative-sequence voltage U_{O2}, and the pre-fault positive-sequence reactive current I_{Qo}. Then a magnitude of the negative-sequence reactive current is limited by using the magnitude limit value for the negative-sequence reactive current, and a magnitude of a positive-sequence reactive current is limited by using the magnitude limit value for the positive-sequence reactive current, so that no overcurrent problem occurs when a converter operates by using a negative-sequence reactive current obtained through magnitude limiting and a positive-sequence reactive current obtained through magnitude limiting.

In this embodiment of this application, a process of obtaining the post-fault positive-sequence voltage U₁, the post-fault negative-sequence voltage U₂, the pre-fault negative-sequence voltage U_{O2}, and the pre-fault positive-sequence reactive current I_{Qo} is not limited. For example, the post-fault positive-sequence voltage U₁, the post-fault negative-sequence voltage U₂, the pre-fault negative-sequence voltage U_{O2}, and the pre-fault positive-sequence reactive current I_{Qo} may be obtained in real time; or the three-phase voltages and three-phase currents at the converter port may be detected in real time, and when the voltage asymmetry fault occurs, the post-fault positive-sequence voltage U₁, the post-fault negative-sequence voltage U₂, the pre-fault negative-sequence voltage U_{O2}, and the pre-fault positive-sequence reactive current I_{Qo} are obtained.

Step 202: Obtain a first current limit value I₁ based on I_{Qo} and U₁, and obtain a second current limit value I₂ based on U₂ and U_{O2}.

To meet requirements for a positive-sequence reactive current during a fault period in different standards, this embodiment of this application provides two implementations of obtaining the first current limit value I₁.

A specific implementation of obtaining the first current limit value I₁ is not limited in this embodiment of this application. Persons skilled in the art may select, according to an actual requirement, a method for obtaining the first current limit value I₁.

### Implementation 1

I_{LMT}I_{LMT}I_{LMT}I_{LMT} The first current limit value I₁ is obtained based on I_{Qo}, U₁, a preset current, the pre-fault positive-sequence voltage U_{O1}, and a rated voltage U_{N} of the converter. Specifically, I₁ is obtained by using the following formula:
I_{LMT}I_{LMT}I_{LMT}I_{LMT}I₁ = |I_{Qo} + K₁ × I_{LMT} × (U_{O1} - U₁)/U_{N}|, where
I_{LMT}I_{LMT}I_{LMT}I_{LMT} and U_{N} are parameters of the converter, both and U_{N} are known values after the converter is determined, K₁ is a preset adjustment coefficient for the positive-sequence reactive current, o < K₁ ≤ ₁₀, and is a rated current of the converter or a maximum current of the converter.

### Implementation 2

I_{LMT}I_{LMT}The first current limit value I₁ is obtained based on I_{Qo}, U₁, a preset current, a preset trigger threshold U_{TR} for a voltage asymmetry fault, and a rated voltage U_{N} of the converter. Specifically, I₁ is obtained by using the following formula:
I_{LMT}I_{LMT}I₁ = |I_{Qo} + K₁× I_{LMT} × (U_{TR} - U₁/U_{N}|, where
I_{LMT}I_{LMT}K₁ is a preset adjustment coefficient for the positive-sequence reactive current, o < K₁≤ ₁₀, U_{TR} may be a low voltage fault trigger threshold or a high voltage fault trigger threshold, and is a rated current of the converter or a maximum current of the converter.

A specific value of U_{TR} is not limited in this embodiment of this application. For a low voltage fault and a high voltage fault, values of U_{TR} are different. U_{TR} corresponding to the high voltage fault is greater than U_{TR} corresponding to the low voltage fault. For example, the low voltage fault trigger threshold is 0.9, and the high voltage fault trigger threshold is 1.1.

The following describes a manner of obtaining the second current limit value I₂.

I_{LMT}The second current limit value I2 is obtained based on U₂, a preset current, a rated voltage U_{N} of the converter, and Uₒ₂. Specifically, I₂ is obtained by using the following formula:
I_{LMT}I₂ = |K₂ × I_{LMT} × (Uₒ₂ - U2)/U_{N}|, where
I_{LMT}K₂ is a preset adjustment coefficient for the negative-sequence reactive current, and o < K₂ ≤ 10.

Step 203: Obtain a third current limit value I₃ based on 1₁ and I₂, and obtain a fourth current limit value I₄ based on I₁ and I₂.

I₃ is directly proportional to 1₁, and I₄ is directly proportional to I₂. Therefore, after I₁ and I₂ are obtained, I₃ and I₄ may be obtained based on 1₁ and I₂. In the technical solution provided in this embodiment of this application, in a process of obtaining I₃ and I₄, the magnitude limit value for the positive-sequence reactive current, namely, I₃, and the magnitude limit value for the negative-sequence reactive current, namely, I₄, are directly obtained without complex iterative operations.

A sequence for obtaining I₃ and I₄ is not limited in this embodiment of this application. I₃ and I₄ may be obtained simultaneously or separately.

For ease of understanding by persons skilled in the art, a specific process of obtaining I₃ is described in detail below, and a process of obtaining I₄ is described in detail subsequently.

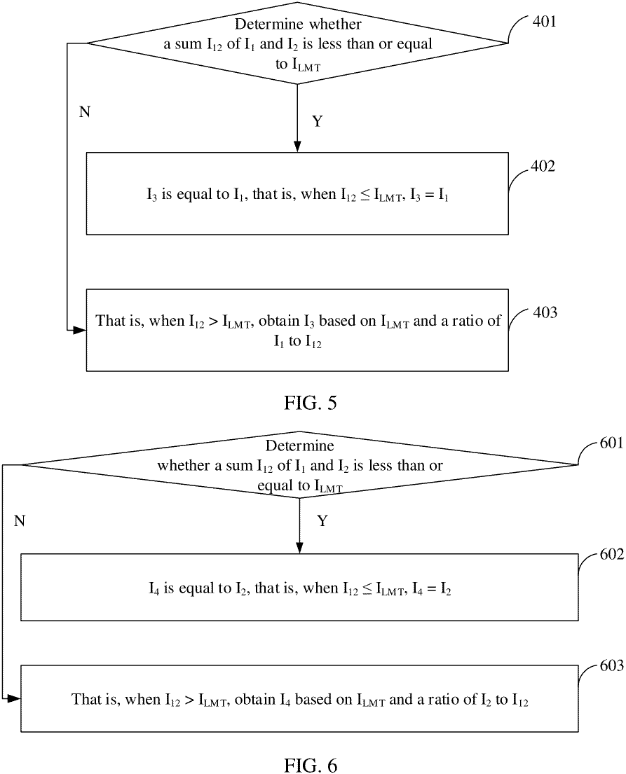

FIG. 5 is a flowchart of a method for obtaining I₃ according to an embodiment of this application.

The method for obtaining the third current limit value in this embodiment of this application includes the following steps.

Step 401: Determine whether a sum 1₁₂ of 1₁ and I₂ is less than or equal to I_{LMT}. If I₁₂ is less than or equal to I_{LMT} (that is, Y in the figure), perform step 402. If 1₁₂ is greater than I_{LMT} (that is, N in the figure), perform step 403.

I₁₂ = 1₁ + I₂.

Step 402: I₃ is equal to I₁To be specific, when I₁₂ ≤ I_{LMT}, I₃ = I₁.

When the sum 1₁₂ of I₁, and I₂ is less than or equal to I_{LMT}, the sum 1₁₂ of I₁ and I₂ that are obtained by using U₁, U₂, U₀₂, and I_{Q0} does not exceed the preset current I_{LMT}. Therefore, I₁ may be directly used as I₃, and the magnitude of the positive-sequence reactive current is limited by using I₃, so that a sum of the positive-sequence reactive current and the negative-sequence reactive current does not exceed the preset current.

Step 403: When I₁₂ > I_{LMT}, obtain I₃ based on I_{LMT} and a ratio of I₁ to I₁₂.

When the sum I₁₂ of I₁ and I₂ is greater than I_{LMT}, the sum I₁₂ of I₁ and I₂ exceeds the preset current I_{LMT} after I₁ and I₂ are obtained by using U₁, U₂, Uₒ₂, and I_{Qo}. Therefore, I₁ needs to be adjusted in an equiproportional manner. Then the magnitude of the positive-sequence reactive current is limited by using I₃ obtained through the adjustment, so that a sum of the positive-sequence reactive current and the negative-sequence reactive current does not exceed the preset current I_{LMT}.

I₃ =

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}} {\text{I}}_{1}$$

A specific process of obtaining I₃ after I₁ is adjusted is as follows:

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}} {\text{I}}_{1} , \left({\text{I}}_{1} + {\text{I}}_{2} > {\text{I}}_{\text{LMT}}\right) ,$$

where I₁ +I₂

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}} {\text{I}}_{1}$$

is the preset current, that is, I₃ is obtained based on an equiproportional relationship of.

With reference to FIG. 2, the solid-line ellipse ₃ is the track of the actual current, that is, the sum I₁₂ of I₁ and I₂.

When the sum I₁₂ of I₁ and I₂ is greater than I_{LMT}, after the magnitude of the positive-sequence reactive current is limited by using I₁, the sum of the positive-sequence reactive current and the negative-sequence reactive current still exceeds the preset current I_{LMT}. Therefore, I₁ needs to be decreased in an equiproportional manner based on I_{LMT} and the ratio of I₁ to I₁₂, to obtain I₃.

Therefore, when the magnitude of the positive-sequence reactive current is limited by using I₃, the sum of the positive-sequence reactive current and the negative-sequence reactive current can be prevented from exceeding the preset current I_{LMT}.

The following describes a process of obtaining I₄.

FIG. 6 is a flowchart of a method for obtaining I₄ according to an embodiment of this application.

The method includes the following steps.

Step 601: Determine whether a sum I₁₂ of I₁ and I₂ is less than or equal to I_{LMT}. If yes (that is, Y in the figure), perform step 602. If no (that is, N in the figure), perform step 603.

I₁₂ = I₁ + I₂.

Step 602: I₄ is equal to I₂. To be specific, when I₁₂ ≤ I_{LMT}, I₄ = I₂.

When the sum I₁₂ of I₁ and I₂ is less than or equal to I_{LMT}, neither I₁ nor I₂ obtained by using U₁, U₂, U₀₂, and I_{Qo} exceeds the preset current I_{LMT}. Therefore, I₂ may be directly used as I₄, and the magnitude of the negative-sequence reactive current is limited by using I₄, so that a sum of the negative-sequence reactive current and the positive-sequence reactive current does not exceed the preset current.

Step 603: When I₁₂ > I_{LMT}, obtain I₄ based on I_{LMT} and a ratio of I₂ to I₁₂.

When the sum I₁₂ of I₁ and I2 is greater than I_{LMT}, the sum I₁₂ of I₁ and I₂ exceeds the preset current I_{LMT} after I₁ and I₂ are obtained by using U₁, U₂, Uₒ₂, and I_{Qo}. Therefore, I₁ and I₂ need to be decreased in an equiproportional manner based on I_{LMT} and the ratio of I₂ to I₁₂, to obtain I₄. Then the magnitude of the negative-sequence reactive current is limited by using I₄ obtained through the adjustment, so that a sum of the negative-sequence reactive current and the positive-sequence reactive current does not exceed the preset current I_{LMT}.

$${\text{I}}_{\text{4}} \text{=} \frac{{\text{I}}_{\text{2}} {\text{×I}}_{\text{LMT}}}{{\text{I}}_{\text{1}} {\text{+I}}_{\text{2}}} {I}_{L M T}$$

A formula for obtaining I₄ after I₂ is adjusted is as follows: [0153]

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}} , \left({\text{I}}_{1} + {\text{I}}_{2} > {\text{I}}_{\text{LMT}}\right) ,$$

where [0154]

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}}$$

is the preset current, that is, I₄ is obtained based on an equiproportional relationship of I₂.

A principle of obtaining I₄ is similar to that of obtaining I₃. For a specific principle, refer to step 403 and FIG. 2. Details are not described herein again.

In the foregoing processes of obtaining I₃ and I₄, I₃ and I₄ are directly obtained by using U₁, U₂, U₀₂, and I_{Q0}, without repeated iterative calculation. Then the magnitude of the positive-sequence reactive current is limited by using I₃ so that the positive-sequence reactive current does not exceed I₃, and the magnitude of the negative-sequence reactive current is limited by using I₄ so that the negative-sequence reactive current does not exceed I₄. Therefore, in the current control method provided in this embodiment of this application, a time required for obtaining a positive-sequence reactive current and a negative-sequence reactive current that meet a requirement can be reduced.

Step 204: Limit the magnitude of the positive-sequence reactive current by using I₃, and limit the magnitude of the negative-sequence reactive current by using I₄.

The magnitude of the positive-sequence reactive current is limited by using I₃, and the magnitude of the negative-sequence reactive current is limited by using I₄, so that the sum of the positive-sequence reactive current and the negative-sequence reactive current does not exceed the preset current I_{LMT}.

Limiting the magnitude of the positive-sequence reactive current by using I₃ may be limiting a magnitude of a commanded value of the positive-sequence reactive current. Specifically, |I_{QI}*| ≤ I₃. Limiting the magnitude of the negative-sequence reactive current by using I₄ may be limiting a magnitude of a commanded value of the negative-sequence reactive current. Specifically, | I_{Q2}* | ≤ I₄.

I_{Q1}* is a commanded value of the positive-sequence reactive current, and I_{Q2}* is a commanded value of the negative-sequence reactive current.

After the magnitude of the commanded value of the positive-sequence reactive current is limited by using I₃, the converter may be controlled based on a magnitude-limited commanded value of the positive-sequence reactive current and a magnitude-limited commanded value of the negative-sequence reactive current. Specifically, a driving pulse signal for a switch in the converter may be generated based on the magnitude-limited commanded value of the positive-sequence reactive current and the magnitude-limited commanded value of the negative-sequence reactive current, so that a current in the converter is not subject to an overcurrent phenomenon.

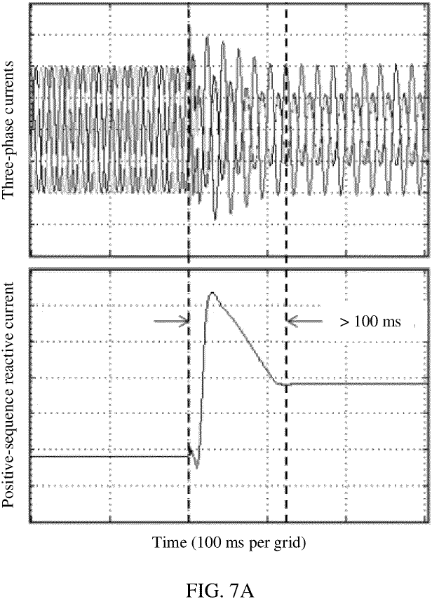

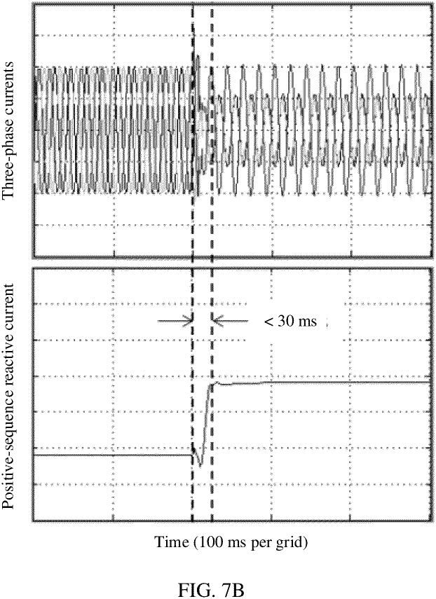

To enable persons skilled in the art to better understand a technical effect of the technical solution provided in this embodiment of this application, the following provides comparative description with reference to a solution in a conventional technology. Refer to FIG. 7A and FIG. 7B. FIG. 7A is an effect diagram of reactive current adjustment in the conventional technology, and FIG. 7B is an effect diagram of reactive current adjustment according to an embodiment of this application.

It can be seen from FIG. 7A that a reactive current adjustment time exceeds 100 ms in the technical solution provided in the conventional technology. However, in FIG. 7B, a reactive current adjustment time is less than 30 ms in the solution provided in this embodiment of this application. Clearly, compared with 100 ms, 30 ms shortens a reactive current adjustment time, thereby meeting a requirement of a power grid for a reactive current adjustment time.

Therefore, in the current control method provided in this embodiment of this application, when the commanded value of the positive-sequence reactive current and the commanded value of the negative-sequence reactive current are generated, the magnitude of the commanded value of the positive-sequence reactive current is limited by using the third current limit value, and the magnitude of the commanded value of the negative-sequence reactive current is limited by using the fourth current limit value, so that the positive-sequence reactive current does not exceed the third current limit value, and the negative-sequence reactive current does not exceed the fourth current limit value, thereby preventing the negative-sequence reactive current injected when the voltage asymmetry fault occurs from causing an overcurrent. In the current control method, a magnitude limit value for the positive-sequence reactive current and a magnitude limit value for the negative-sequence reactive current may be directly obtained at a time, without repeated iterative calculation. A positive-sequence reactive current and a negative-sequence reactive current that meet a requirement are obtained within a relatively short time, so that a reactive current adjustment time can be shortened. In the technical solution provided in this application, when a voltage asymmetry fault occurs, a positive-sequence reactive current and a negative-sequence reactive current that meet a requirement may be injected into a power grid while a time requirement is met, to resolve a problem that a negative-sequence reactive current causes an overcurrent for a converter.

### Method Embodiment 2

In a current control method provided in the embodiment 2 of this application, on a basis of limiting a magnitude of a positive-sequence reactive current and limiting a magnitude of a negative-sequence reactive current, a magnitude of a positive-sequence active current is further limited.

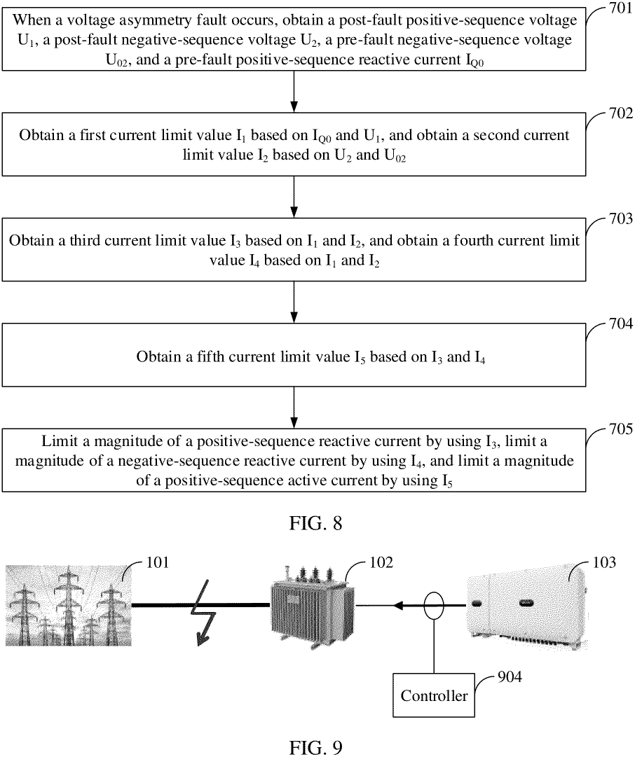

FIG. 8 is a flowchart of a current control method according to an embodiment of this application.

Step 701 to step 703 are similar to step 201 to step 203 in the method embodiment 1, and details are not described herein again.

On a basis of step 701 to step 703, the method further includes the following steps.

Step 704: Obtain a fifth current limit value I₅ based on I₃ and I₄.

When a voltage asymmetry fault occurs on a power grid, a magnitude of a positive-sequence active current further needs to be limited to ensure safety.

Therefore, the magnitude of the positive-sequence active current further needs to be limited while a magnitude of a reactive current is limited.

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3} \text{A}$$

formula for obtaining the fifth current limit value I₅ based on I₃ and I₄ is as follows: [0174]

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3} {\text{I}}_{5} =$$

max, where

$$\left[\sqrt{{\left({\text{I}}_{\text{LMT}} - \left|{\text{I}}_{4}\right|\right)}^{2} - {\left|{\text{I}}_{3}\right|}^{2} ,} {\text{K}}_{3} \times {\text{I}}_{\text{LMT}}\right] {\text{I}}_{\text{LMT}} {\text{K}}_{3}$$

is the preset current, is a preset adjustment coefficient for the positive-sequence active current, and o < K₃ ≤ 1.

It can be learned from the foregoing formula that a value of I₅ is a larger value of

$$\sqrt{{\left({\text{I}}_{\text{LMT}} - \left|{\text{I}}_{4}\right|\right)}^{2} - {\left|{\text{I}}_{3}\right|}^{2}} {\text{and K}}_{3} \times {\text{I}}_{\text{LMT}} .$$

and

When

$$\sqrt{{\left({\text{I}}_{\text{LMT}} - \left|{\text{I}}_{4}\right|\right)}^{2} - {\left|{\text{I}}_{3}\right|}^{2}} > {\text{K}}_{3} \times {\text{I}}_{\text{LMT}} {\text{,I}}_{5} = \sqrt{{\left({\text{I}}_{\text{LMT}} - \left|{\text{I}}_{4}\right|\right)}^{2} - {\left|{\text{I}}_{3}\right|}^{2}} .$$

When

$$\sqrt{{\left({\text{I}}_{\text{LMT}} - \left|{\text{I}}_{4}\right|\right)}^{2} - {\left|{\text{I}}_{3}\right|}^{2}} < {\text{K}}_{3} \times {\text{I}}_{\text{LMT}} , {\text{I}}_{5} = {\text{K}}_{3} \times {\text{I}}_{\text{LMT}} .$$

When

$$\sqrt{{\left({\text{I}}_{\text{LMT}} - \left|{\text{I}}_{4}\right|\right)}^{2} - {\left|{\text{I}}_{3}\right|}^{2}} = {\text{K}}_{3} \times {\text{I}}_{\text{LMT}} , {\text{a value of I}}_{5}$$

a value of I₅ may be

In the current control method provided in this embodiment of this application, in a process of obtaining I₅, after I₃ and I₄ are obtained, I₅ may be directly obtained based on I₃ and I₄, without repeated iterative calculation, thereby reducing a time for obtaining a positive-sequence active current that meets a requirement. Therefore, with the technical solution provided in this application, a converter can limit a magnitude of a positive-sequence active current, limit a magnitude of a positive-sequence reactive current, and limit a magnitude of a negative-sequence reactive current within a relatively short time.

Step 705: Limit a magnitude of a positive-sequence reactive current by using I₃, limit a magnitude of a negative-sequence reactive current by using I₄, and limit a magnitude of a positive-sequence active current by using I₅.

For specific processes of limiting the magnitude of the positive-sequence reactive current by using I₃ and limiting the magnitude of the negative-sequence reactive current by using I₄, refer to step 204 in the method embodiment 1. Details are not described herein again. The limiting a magnitude of a positive-sequence active current by using I₅ is described in detail below.

The limiting a magnitude of a positive-sequence active current by using I₅ may be limiting a magnitude of a commanded value of the positive-sequence active current. Specifically, |I_{P1}*| ≤ I₅.

I_{P1}* is a commanded value of the positive-sequence active current.

After the magnitude of the commanded value of the positive-sequence active current, the magnitude of the commanded value of the positive-sequence reactive current, and the magnitude of the commanded value of the negative-sequence reactive current are limited, the converter may be controlled based on a magnitude-limited commanded value of the positive-sequence active current, a magnitude-limited commanded value of the positive-sequence reactive current, and a magnitude-limited commanded value of the negative-sequence reactive current. Specifically, a driving pulse signal for a switch in the converter may be generated based on the magnitude-limited commanded value of the positive-sequence active current, the magnitude-limited commanded value of the positive-sequence reactive current, and the magnitude-limited commanded value of the negative-sequence reactive current, so that a current in the converter is not subject to an overcurrent phenomenon.

In the current control method provided in this embodiment of this application, a magnitude limit value for the positive-sequence active current, a magnitude limit value for the positive-sequence reactive current, and a magnitude limit value for the negative-sequence reactive current may be directly obtained at a time. A positive-sequence active current, a negative-sequence reactive current, and a positive-sequence reactive current that meet a requirement can be obtained without repeated iterative calculation, thereby reducing a time required for obtaining the positive-sequence active current, the negative-sequence reactive current, and the positive-sequence reactive current that meet the requirement. Therefore, the converter can inject the positive-sequence reactive current and the negative-sequence reactive current that meet the requirement into the power grid while meeting a time requirement, thereby resolving a problem that a negative-sequence reactive current causes an overcurrent for a converter.

### System Embodiment 1

FIG. 9 is a schematic diagram of a converter system according to an embodiment of this application.

The converter system includes at least a converter 103 and a controller 904.

In some implementations, the converter system further includes a transformer 102. An example in which the converter system includes the transformer 102 is used for description below.

A first side of the converter 103 is used to connect to a direct current, and a second side of the converter 103 is used to connect to a first side of the transformer 102.

The converter 103 may be a bidirectional converter. To be specific, the converter 103 may convert a direct current into an alternating current and transmit the alternating current to a power grid 101, or may rectify an alternating current transmitted by the power grid 101 into a direct current.

A second side of the transformer 102 is used to connect to the power grid 101.

The transformer 102 may perform voltage transformation on the alternating current transmitted by the converter 103, and then transmit the alternating current to the power grid 101 through a transmission line.

A scenario in an actual operating process is relatively complex. Therefore, a voltage asymmetry fault, such as a single-phase fault or a two-phase fault, is likely to occur on the transmission line. In this case, a positive-sequence reactive current and a negative-sequence reactive current may be injected into the power grid 101 while ensuring that the converter 103 is on the grid. However, the negative-sequence reactive current is likely to cause three-phase current imbalance for the converter 103.

To resolve an overcurrent problem of a current and meet a requirement of the power grid for a reactive current adjustment time, in this system embodiment of this application, the controller 904 obtains a magnitude limit value for the positive-sequence reactive current and a magnitude limit value for the negative-sequence reactive current at a time, without repeated iterative calculation, so that the reactive current adjustment time can be shortened. Then the controller 904 limits a magnitude of a positive-sequence reactive current by using the magnitude limit value for the positive-sequence reactive current, and limits a magnitude of the negative-sequence reactive current by using the magnitude limit value for the negative-sequence reactive current. Therefore, when a voltage asymmetry fault occurs on the power grid, a requirement for a reactive current adjustment time in an on-grid standard can be met, and an overcurrent problem can also be resolved for the converter.

Specifically, the controller 904 is configured to, when a voltage asymmetry fault occurs, obtain a post-fault positive-sequence voltage U₁, a post-fault negative-sequence voltage U₂, a pre-fault negative-sequence voltage U_{O2}, and a pre-fault positive-sequence reactive current I_{QO}; obtain a first current limit value I₁ based on I_{QO} and U₁, and obtain a second current limit value I₂ based on U₂ and U_{O2}; obtain a third current limit value I₃ based on I₁, and I₂, and obtain a fourth current limit value I₄ based on I₁, and I₂; and limit a magnitude of a positive-sequence reactive current by using I₃, and limit a magnitude of a negative-sequence reactive current by using I₄.

The controller 904 may determine, by obtaining three-phase voltages at a port of the converter 103, whether a voltage asymmetry fault occurs. For a specific determining process, refer to the method embodiment 1 and FIG. 4. Details are not described herein again.

After determining that a voltage asymmetry fault occurs, the controller 904 obtains the first current limit value I₁ based on I_{QO} and U₁, and obtains the second current limit value I₂ based on U₂ and U_{O2}.

That the controller 904 obtains I₁ based on I_{QO} and U₁ is first described below, and the obtaining I₂ based on U₂ and U_{O2} is described subsequently.

To meet two different current limiting standards, the controller 904 may obtain I₁, in two different manners.

### Manner 1

I_{LMT}I_{LMT}I_{LMT}I_{LMT}The controller 904 obtains the first current limit value I₁, based on I_{QO}, U₁, a preset current, the pre-fault positive-sequence voltage U_{O1}, and a rated voltage U_{N} of the converter. Specifically, I₁ is obtained by using the following formula:
I_{LMT}I_{LMT}I_{LMT}I_{LMT}I₁ = |I_{QO} + K₁ × I_{LMT} × (U_{O1} - U₁)/U_{N}|, where
I_{LMT}I_{LMT}I_{LMT}I_{LMT} and U_{N} are parameters of the converter, both and U_{N} are known values after the converter is determined, K₁ is a preset adjustment coefficient for the positive-sequence reactive current, 0 < K₁ ≤ 10, and is a rated current of the converter or a maximum current of the converter.

### Manner 2

I_{LMT}I_{LMT} The controller 904 obtains the first current limit value I₁ based on I_{QO}, U₁, a preset current, a preset trigger threshold U_{TR} for a voltage asymmetry fault, and a rated voltage U_{N} of the converter. Specifically, I₁, is obtained by using the following formula:
I_{LMT}I_{LMT}I₁ = |I_{QO} + K₁ × I_{LMT} × (U_{TR} - U₁)/U_{N}|, where
I_{LMT}I_{LMT}K₁ is a preset adjustment coefficient for the positive-sequence reactive current, 0 < K₁ ≤ 10, U_{TR} may be a low voltage fault trigger threshold or a high voltage fault trigger threshold, and is a rated current of the converter or a maximum current of the converter.

The following describes a manner of obtaining I₂.

I_{LMT} The controller 904 obtains the second current limit value I₂ based on U₂, a preset current, a rated voltage U_{N} of the converter, and U_{O2}. Specifically, I₂ is obtained by using the following formula:
I_{LMT}I₂ = |K₂ × I_{LMT} × (U_{O2} - U₂)/U_{N}|, where
I_{LMT}K₂ is a preset adjustment coefficient for the negative-sequence reactive current, and 0 < K₂ ≤ 10.

I₃ is directly proportional to I₁, and I₄ is directly proportional to I₂. Therefore, after obtaining I₁ and I₂, the controller 904 may obtain I₃ and I₄ based on I₁ and I₂. In processes of obtaining I₃ and I₄, the controller 904 directly obtains a magnitude limit value for the positive-sequence reactive current, namely, I₃, and directly obtains a magnitude limit value for the negative-sequence reactive current, namely, I₄, without complex iterative operations.

A specific process of obtaining I₃ by the controller 904 based on I₁ and I₂ is as follows.

The controller 904 determines whether a sum I₁₂ of I₁, and I₂ is less than or equal to I_{LMT}, that is, I₁₂ = I₁ + I₂. If I₁₂ is less than or equal to I_{LMT}, the sum I₁₂ of I₁ and I₂ that are obtained by using U₁, U₂, U_{O2}, and I_{QO} does not exceed the preset current I_{LMT}. Therefore, the controller 904 may directly use I₁ as I₃, that is, when I₁₂ ≤ I_{LMT}, I₃ = I₁, and limit the magnitude of the positive-sequence reactive current by using I₃, so that a sum of the positive-sequence reactive current and the negative-sequence reactive current does not exceed the preset current. If I₁₂ is greater than I_{LMT}, the sum I₁₂ of I₁, and I₂ exceeds the preset current I_{LMT}, that is, I₁₂ > I_{LMT}, after I₁ and I₂ are obtained by using U₁, U₂, U_{O2}, and I_{QO}. Therefore, the controller 904 needs to adjust I₁ in an equiproportional manner, and then limit the magnitude of the positive-sequence reactive current by using I₃ obtained through the adjustment, so that a sum of the positive-sequence reactive current and the negative-sequence reactive current does not exceed the preset current I_{LMT}.

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}} {\text{I}}_{1}$$

Specifically, the controller may adjust I₁, in an equiproportional manner by using the following formula:

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}} {\text{I}}_{1} , \left({\text{I}}_{1} + {\text{I}}_{2} > {\text{I}}_{\text{LMT}}\right) , \text{where}$$

$${\text{I}}_{3} = \frac{{\text{I}}_{1} \times {\text{I}}_{\text{LMT}}}{{\text{I}}_{1} + {\text{I}}_{2}} {\text{I}}_{\text{LMT}} {\text{I}}_{1}$$

is the preset current, that is, I₃ is obtained based on an equiproportional relationship of.

When the sum I₁₂ of I₁, and I₂ is greater than I_{LMT}, after the magnitude of the positive-sequence reactive current is limited by using I₁, the sum of the positive-sequence reactive current and the negative-sequence reactive current still exceeds the preset current I_{LMT}. Therefore, I₁, and I₂ need to be decreased in an equiproportional manner based on I_{LMT} and a ratio of I₁ to I₁₂, to obtain I₃, so that a sum I₁₂ of I₃ obtained through the decrease and decreased I₂ does not exceed the preset current I_{LMT}.

Therefore, when the controller 904 limits the magnitude of the positive-sequence reactive current by using I₃, the sum of the positive-sequence reactive current and the negative-sequence reactive current can be prevented from exceeding the preset current I_{LMT}.

A specific process of obtaining I₄ by the controller 904 based on I₁ and I₂ is as follows.

The controller 904 determines whether a sum I₁₂ of I₁ and I₂ is less than or equal to I_{LMT}, that is, I₁₂ = I₁ + I₂. If yes, neither I₁, nor I₂ obtained by using U₁, U₂, U_{O2}, and I_{QO} exceeds the preset current I_{LMT}. Therefore, I₂ may be directly used as I₄, that is, when I₁₂ ≤ I_{LMT}, I₄ = I₂, and the magnitude of the negative-sequence reactive current is limited by using I₄, so that a sum of the negative-sequence reactive current and the positive-sequence reactive current does not exceed the preset current. If no, the sum I₁₂ of I₁, and I₂ exceeds the preset current I_{LMT}, that is, I₁₂ > I_{LMT}, after I₁, and I₂ are obtained by using U₁, U₂, U_{O2}, and I_{QO}. Therefore, I₂ needs to be decreased in an equiproportional manner based on I_{LMT} and a ratio of I₂ to I₁₂, to obtain I₄. Then the magnitude of the negative-sequence reactive current is limited by using I₄ obtained through the adjustment, so that a sum of the negative-sequence reactive current and the positive-sequence reactive current does not exceed the preset current I_{LMT}.

$${\text{I}}_{4} = \frac{{\text{I}}_{2} \times {\text{I}}_{\text{LMT}}}{{\text{I}}_{1} + {\text{I}}_{2}} {\text{I}}_{\text{LMT}}$$

Specifically, the controller may adjust I₂ in an equiproportional manner by using the following formula:

$${\text{I}}_{4} = \frac{{\text{I}}_{2} \times {\text{I}}_{\text{LMT}}}{{\text{I}}_{1} + {\text{I}}_{\text{2}}} {\text{I}}_{\text{LMT}} , \left({\text{I}}_{\text{1}} + {\text{I}}_{\text{2}} > {\text{I}}_{\text{LMT}}\right) , \text{where}$$

$${\text{I}}_{\text{4}} = \frac{{\text{I}}_{\text{2}} \times {\text{I}}_{\text{LMT}}}{{\text{I}}_{\text{1}} + {\text{I}}_{2}} {\text{I}}_{\text{LMT}}$$

is the preset current, that is, I₄ is obtained based on an equiproportional relationship of I₂.

In the processes of obtaining I₃ and I₄ by the controller 904, I₃ and I₄ are directly obtained by using U₁, U₂, U_{O2}, and I_{QO}, without repeated iterative calculation. Then the magnitude of the positive-sequence reactive current is limited by using I₃ so that the positive-sequence reactive current does not exceed I₃, and the magnitude of the negative-sequence reactive current is limited by using I₄ so that the negative-sequence reactive current does not exceed I₄. Therefore, in the converter system provided in this embodiment of this application, a time required for obtaining a positive-sequence reactive current and a negative-sequence reactive current that meet a requirement can be reduced.

After obtaining I₃ and I₄, the controller 904 limits the magnitude of the positive-sequence reactive current by using I₃, and limits the magnitude of the negative-sequence reactive current by using I₄, so that the sum of the positive-sequence reactive current and the negative-sequence reactive current does not exceed the preset current I_{LMT}.

Specifically, the controller 904 may limit a magnitude of a commanded value of the positive-sequence reactive current by using I₃, to achieve an objective of limiting the magnitude of the positive-sequence reactive current. Similarly, the controller 904 may also limit a magnitude of a commanded value of the negative-sequence reactive current by using I₄.

That the controller 904 limits the magnitude of the commanded value of the positive-sequence reactive current by using I₃ is described below.

The controller 904 specifies that |I_{Q1}*| ≤ I₃, where I_{Q1}* is the commanded value of the positive-sequence reactive current.

That the controller 904 limits the magnitude of the commanded value of the negative-sequence reactive current by using I₄ is described below.

The controller 904 specifies that |I_{Q2}*| ≤ I₄, where I_{Q2}* is the commanded value of the negative-sequence reactive current.

After limiting the magnitude of the commanded value of the positive-sequence reactive current by using I₃, the controller 904 may control the converter based on a magnitude-limited commanded value of the positive-sequence reactive current and a magnitude-limited commanded value of the negative-sequence reactive current. Specifically, a driving pulse signal for a switch in the converter may be generated based on the magnitude-limited commanded value of the positive-sequence reactive current and the magnitude-limited commanded value of the negative-sequence reactive current, so that a current in the converter is not subject to an overcurrent phenomenon.

Therefore, in the converter system provided in this embodiment of this application, when generating the commanded value of the positive-sequence reactive current and the commanded value of the negative-sequence reactive current, the controller may limit the magnitude of the commanded value of the positive-sequence reactive current by using the third current limit value, and limit the magnitude of the commanded value of the negative-sequence reactive current by using the fourth current limit value, so that the positive-sequence reactive current does not exceed the third current limit value, and the negative-sequence reactive current does not exceed the fourth current limit value, thereby preventing the negative-sequence reactive current injected when the voltage asymmetry fault occurs from causing an overcurrent. The controller in the converter system may directly obtain the magnitude limit value for the positive-sequence reactive current and the magnitude limit value for the negative-sequence reactive current at a time, without repeated iterative calculation. A positive-sequence reactive current and a negative-sequence reactive current that meet a requirement are obtained within a relatively short time, so that a reactive current adjustment time can be shortened. In the technical solution provided in this embodiment of this application, when a voltage asymmetry fault occurs, a positive-sequence reactive current and a negative-sequence reactive current that meet a requirement may be injected into a power grid while a time requirement is met, to resolve a problem that a negative-sequence reactive current causes an overcurrent for a converter.

### System Embodiment 2

With reference to FIG. 9, on a basis of limiting a magnitude of a positive-sequence reactive current and limiting a magnitude of a negative-sequence reactive current, the controller 904 further limits a magnitude of a positive-sequence active current.

The controller 904 may obtain a fifth current limit value I₅ based on I₃ and I₄.

When a voltage asymmetry fault occurs on a power grid, a magnitude of a positive-sequence active current further needs to be limited to ensure safety.

Therefore, the controller 904 further needs to limit the magnitude of the positive-sequence active current while limiting a magnitude of a reactive current. Therefore, a sum of the positive-sequence active current, the positive-sequence reactive current, and the negative-sequence reactive current meets a requirement of a preset current.

$$\left[\sqrt{{\left({\text{I}}_{\text{LMT}} - \left|{\text{I}}_{\text{4}}\right|\right)}^{2} - {\left|{\text{I}}_{3}\right|}^{2}} {\text{,K}}_{3} \times {\text{I}}_{\text{LMT}}\right] {\text{I}}_{\text{LMT}} {\text{K}}_{\text{3}}$$

A formula for obtaining the fifth current limit value I₅ by the controller 904 based on I₃ and I₄ is as follows:

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3} {\text{I}}_{5} = \text{max, where}$$

$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3}$$

is the preset current, is a preset adjustment coefficient for the positive-sequence active current, and 0 < K₃ ≤ 1.

It can be learned from the foregoing formula that a value of I₅ is a larger value of

$$\sqrt{{\left({\text{I}}_{\text{LMT}} - \left|{\text{I}}_{4}\right|\right)}^{2} - {\left|{\text{I}}_{3}\right|}^{2}} {\text{and K}}_{3} \times {\text{I}}_{\text{LMT}} .$$

When

$$\sqrt{{\left({\text{I}}_{\text{LMT}} - \left|{\text{I}}_{4}\right|\right)}^{2} - {\left|{\text{I}}_{3}\right|}^{2}} {\text{> K}}_{3} \times {\text{I}}_{\text{LMT}} , {\text{I}}_{5} = \sqrt{{\left({\text{I}}_{\text{LMT}} - \left|{\text{I}}_{4}\right|\right)}^{2} - {\left|{\text{I}}_{3}\right|}^{2}} .$$

When

$$\sqrt{{\left({\text{I}}_{\text{LMT}} - \left|{\text{I}}_{4}\right|\right)}^{2} - {\left|{\text{I}}_{3}\right|}^{2}} {\text{< K}}_{3} \times {\text{I}}_{\text{LMT}} , {\text{I}}_{5} = {\text{K}}_{3} \times {\text{I}}_{\text{LMT}} .$$

When

$$\sqrt{{\left({\text{I}}_{\text{LMT}} - \left|{\text{I}}_{4}\right|\right)}^{2} - {\left|{\text{I}}_{3}\right|}^{2}} {\text{= K}}_{3} \times {\text{I}}_{\text{LMT}} ,$$

a value of I₅ may be

$$\sqrt{{\left({\text{I}}_{\text{LMT}} - \left|{\text{I}}_{4}\right|\right)}^{2} - {\left|{\text{I}}_{3}\right|}^{2}} {\text{or K}}_{3} \times {\text{I}}_{\text{LMT}} .$$

In a process of obtaining I₅, after obtaining I₃ and I₄, the controller 904 may directly obtain I₅ based on I₃ and I₄, without repeated iterative calculation, thereby reducing a time for obtaining a positive-sequence active current that meets a requirement. Therefore, the converter 103 can limit the magnitude of the positive-sequence active current, limit the magnitude of the positive-sequence reactive current, and limit the magnitude of the negative-sequence reactive current within a relatively short time.

That the controller 904 limits the magnitude of the positive-sequence active current by using I₅ may be limiting a magnitude of a commanded value of the positive-sequence active current. Specifically, |I_{P1}*| ≤ I₅.

I_{P1}* is a commanded value of the positive-sequence active current.

After limiting the magnitude of the commanded value of the positive-sequence active current, the magnitude of the commanded value of the positive-sequence reactive current, and the magnitude of the commanded value of the negative-sequence reactive current, the controller may control the converter based on a magnitude-limited commanded value of the positive-sequence active current, a magnitude-limited commanded value of the positive-sequence reactive current, and a magnitude-limited commanded value of the negative-sequence reactive current. Specifically, a driving pulse signal for a switch in the converter may be generated based on the magnitude-limited commanded value of the positive-sequence active current, the magnitude-limited commanded value of the positive-sequence reactive current, and the magnitude-limited commanded value of the negative-sequence reactive current, so that a current in the converter is not subject to an overcurrent phenomenon.

In the converter system provided in this embodiment of this application, the controller may directly obtain a magnitude limit value for the positive-sequence active current, a magnitude limit value for the positive-sequence reactive current, and a magnitude limit value for the negative-sequence reactive current at a time. A positive-sequence active current, a negative-sequence reactive current, and a positive-sequence reactive current that meet a requirement can be obtained without repeated iterative calculation, thereby reducing a time required for obtaining the positive-sequence active current, the negative-sequence reactive current, and the positive-sequence reactive current that meet the requirement. Therefore, the converter can inject the positive-sequence reactive current and the negative-sequence reactive current that meet the requirement into the power grid while meeting a time requirement, thereby resolving a problem that a negative-sequence reactive current causes an overcurrent for a converter.

It should be understood that, in this application, “at least one” means one or more, and “a plurality of” means two or more. The term “and/or” is used to describe an association relationship between associated objects, and represents that three relationships may exist. For example, “A and/or B” may represent the following three cases: Only A exists, only B exists, and both A and B exist, where A and B may be singular or plural. The character “/” usually indicates an “or” relationship between the associated objects. “At least one of the following items (pieces)” or a similar expression thereof indicates any combination of these items, including a single item (piece) or any combination of a plurality of items (pieces). For example, at least one (piece) of a, b, or c may represent: a, b, c, “a and b”, “a and c”, “b and c”, or “a, b, and c”, where a, b, and c may be singular or plural.

The foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of this application.

What is claimed is:

1. A current control method, comprising:
obtaining, based on a voltage asymmetry fault occurring, a post-fault positive-sequence voltage (U)₁, a post-fault negative-sequence voltage (U₂), a pre-fault negative-sequence voltage (U_{O2}), and a pre-fault positive-sequence reactive current (I_{Qo});
obtaining a first current limit value (I₁) based on I_{Qo} and U₁;
obtaining a second current limit value (I₂) based on U₂ and U_{O2};
obtaining a third current limit value (I₃) based on I₁ and I₂;
obtaining a fourth current limit value (I₄) based on I₁ and I₂, wherein I₃ is directly proportional to I₁, and I₄ is directly proportional to I₂;
limiting a magnitude of a positive-sequence reactive current based on I₃; and
limiting a magnitude of a negative-sequence reactive current based on I₄.

2. The method according to claim 1, wherein a fifth current limit value (I₅) is obtained based on I₃ and I₄, and a magnitude of a positive-sequence active current is limited based on I₅.

3. The method according to claim 2, wherein the obtaining a fifth current limit value (I₅) based on I₃ and I₄ comprises:
obtaining I₅ based on I₃, I₄, and a preset current, wherein the preset current is one of a rated current of a converter or a maximum current of the converter.
$$\left[\sqrt{\left({\text{I}}_{\text{LMT}} - {\left|{\text{I}}_{4}\right|}^{2}\right) - {\left|{\text{I}}_{3}\right|}^{2}} , {\text{K}}_{3} \times {\text{I}}_{\text{LMT}}\right] {\text{I}}_{\text{LMT}} {\text{K}}_{3} 4 .$$
The method according to claim 3, wherein the obtaining I₅ based on I₃, I₄, and a preset current comprises obtaining I₅ by using the formula:
$$\left[\sqrt{{\left({\text{I}}_{\text{LMT}} - \left|{\text{I}}_{4}\right|\right)}^{2} - {\left|{\text{I}}_{3}\right|}^{2}} , {\text{K}}_{3} \times {\text{I}}_{\text{LMT}}\right] {\text{I}}_{\text{LMT}} {\text{K}}_{3} {\text{I}}_{5} = max ,$$
wherein is the preset current, is a preset adjustment coefficient for the positive-sequence active current, and o < K₃ ≤ 1.

5. The method according to claim 2, wherein the limiting a magnitude of a positive-sequence active current by using I₅ comprises:
setting I_{P1}* such that |I_{P1}*| ≤ I₅, wherein I_{P1}* is a commanded value of the positive-sequence active current.

6. The method according to claim 1, wherein the obtaining I₃ based on I₁ and I₂ comprises:
setting, based on a sum I₁₂ of I₁ and I₂ being less than or equal to a preset current, I₃ equal to I₁, wherein the preset current is one of a rated current of a converter or a maximum current of the converter; or
obtaining, based on the sum I₁₂ of I₁ and I₂ being greater than the preset current, I₃ based on the preset current and a ratio of I₁ to I₁₂.
$${\text{I}}_{3} = \frac{{\text{I}}_{1} \times {\text{I}}_{\text{LMT}}}{{\text{I}}_{1} + {\text{I}}_{2}} {\text{I}}_{\text{LMT}} 7 .$$
The method according to claim 6, wherein the obtaining I₃ based on the preset current and a ratio of I₁ to I₁₂ comprises obtaining I₃ by using the formula:
$${\text{I}}_{\text{3}} \text{=} \frac{{\text{I}}_{\text{1}} \text{×} {\text{I}}_{\text{LMT}}}{{\text{I}}_{\text{1}} \text{+} {\text{I}}_{\text{2}}} {\text{I}}_{\text{LMT}} \text{,}$$
wherein is the preset current.

8. The method according to claim 1, wherein the obtaining I₄ based on I₁ and I₂ comprises:
setting, based on a sum I₁₂ of I₁ and I₂ being less than or equal to a preset current, I₄ equal to I₂, wherein the preset current is one of a rated current of a converter or a maximum current of the converter; or
obtaining, based on the sum I₁₂ of I₁ and I₂ being greater than the preset current, I₄ based on the preset current and a ratio of I₂ to I₁₂.
$${\text{I}}_{\text{4}} \text{=} \frac{{\text{I}}_{\text{2}} \text{×} {\text{I}}_{\text{LMT}}}{{\text{I}}_{\text{1}} \text{+} {\text{I}}_{\text{2}}} {\text{I}}_{\text{LMT}} \text{9} \text{.}$$
The method according to claim 8, wherein the obtaining I₄ based on the preset current and a ratio of I₂ to I₁₂ comprises obtaining I₄ by using the formula:
$${\text{I}}_{\text{4}} \text{=} \frac{{\text{I}}_{\text{2}} \text{×} {\text{I}}_{\text{LMT}}}{{\text{I}}_{\text{1}} \text{+} {\text{I}}_{\text{2}}} {\text{I}}_{\text{LMT}} ,$$
wherein is the preset current.

10. The method according to claim 1, wherein the limiting a magnitude of a positive-sequence reactive current based on I₃, and limiting a magnitude of a negative-sequence reactive current based on I₄ comprises:
setting I_{Q1}* and I_{Q2}* such that |I_{Q1}*| ≤ I₃, |I_{Q2}*| ≤ I₄, wherein I_{Q1}* is a commanded value of the positive-sequence reactive current, and I_{Q2}* is a commanded value of the negative-sequence reactive current.

11. A converter system, comprising
a converter, wherein a first side of the converter is configured to be connected to a direct current, and a second side of the converter is configured to be connected to a power grid, and wherein at least one of:
the converter is configured to convert a direct current into an alternating current and transmit the alternating current to the power grid; or
the converter is configured to rectify an alternating current transmitted by the power grid into a direct current; and
a controller, wherein the controller is configured to:
obtain, based on a voltage asymmetry fault occurring: a post-fault positive-sequence voltage (U₁), a post-fault negative-sequence voltage (U₂), a pre-fault negative-sequence voltage (U_{O2}), and a pre-fault positive-sequence reactive current (I_{Qo});
obtain a first current limit value (I₁) based on I_{Qo} and U₁,
obtain a second current limit value (I₂) based on U₂ and U_{O2};
obtain a third current limit value (I₃) based on I₁ and I₂,
obtain a fourth current limit value (I₄) based on I₁ and I₂;
limit a magnitude of a positive-sequence reactive current based on I₃, and
limit a magnitude of a negative-sequence reactive current based on I₄,
wherein I₃ is directly proportional to I₁, and I₄ is directly proportional to I₂.

12. The system according to claim 11, wherein the controller is further configured to:
obtain a fifth current limit value (I₅) based on I₃ and I₄; and
limit a magnitude of a positive-sequence active current based on I₅.

13. The system according to claim 12, wherein the controller is configured to obtain I₅ based on I₃, I₄, and a preset current, wherein the preset current is one of a rated current of the converter or a maximum current of the converter.
$$\left[\sqrt{{\left({\text{I}}_{\text{LMT}} - \left|{\text{I}}_{\text{4}}\right|\right)}^{\text{2}} - {\left|{\text{I}}_{\text{3}}\right|}^{\text{2}}} {\text{,K}}_{\text{3}} \text{×} {\text{I}}_{\text{LMT}}\right] {\text{I}}_{\text{LMT}} {\text{K}}_{\text{3}} \text{14} \text{.}$$
The system according to claim 13, wherein the controller is configured to obtain I₅ by using the formula:
$$\left[\sqrt{{\left({\text{I}}_{\text{LMT}} - \left|{\text{I}}_{\text{4}}\right|\right)}^{\text{2}} - {\left|{\text{I}}_{\text{3}}\right|}^{\text{2}}} {\text{,K}}_{\text{3}} \text{×} {\text{I}}_{\text{LMT}}\right] {\text{I}}_{\text{LMT}} {\text{K}}_{\text{3}} {\text{I}}_{\text{5}} \text{=max} \text{,}$$
wherein is the preset current, is a preset adjustment coefficient for the positive-sequence active current, and o < K₃ ≤ 1.

15. The system according to claim 12, wherein the controller is configured to limit the magnitude of the positive-sequence active current setting I_{P1}* such that:

|I_{P1}*| ≤ I₅, wherein I_{P1}* is a commanded value of the positive-sequence active current.

16. The system according to claim 11, wherein the controller is configured to:
make, based on a sum I₁₂ of I₁ and I₂ being less than or equal to a preset current, I₃ be equal to I₁, wherein the preset current is one of a rated current of the converter or a maximum current of the converter; or
obtain, based on the sum I₁₂ of I₁ and I₂ being greater than the preset current, I₃ based on the preset current and a ratio of I₁ to I₁₂.
$${\text{I}}_{\text{3}} \text{=} \frac{{\text{I}}_{\text{1}} \text{×} {\text{I}}_{\text{LMT}}}{{\text{I}}_{\text{1}} \text{+} {\text{I}}_{\text{2}}} {\text{I}}_{\text{LMT}} \text{17} \text{.}$$
The system according to claim 16, wherein the controller is configured to obtain I₃ by using the formula:
$${\text{I}}_{\text{3}} \text{=} \frac{{\text{I}}_{\text{1}} \text{×} {\text{I}}_{\text{LMT}}}{{\text{I}}_{\text{1}} \text{+} {\text{I}}_{\text{2}}} {\text{I}}_{\text{LMT}} \text{,}$$
wherein is the preset current.

18. The system according to claim 11, wherein the controller is configured to:
make, based on a sum I₁₂ of I₁ and I₂ being less than or equal to a preset current, I₄ be equal to I₂, wherein the preset current is one of a rated current of the converter or a maximum current of the converter; or
obtain, based on the sum I₁₂ of I₁ and I₂ being greater than the preset current, I₄ based on the preset current and a ratio of I₂ to I₁₂.
$${\text{I}}_{\text{4}} \text{=} \frac{{\text{i}}_{\text{2}} {\text{×i}}_{\text{LMT}}}{{\text{I}}_{\text{1}} {\text{+I}}_{\text{2}}} {\text{I}}_{\text{LMT}} \text{19} \text{.}$$
The system according to claim 18, wherein the controller is configured to obtain I₄ by using the formula:
$${\text{I}}_{\text{4}} \text{=} \frac{{\text{i}}_{\text{2}} {\text{×i}}_{\text{LMT}}}{{\text{I}}_{\text{1}} {\text{+I}}_{\text{2}}} {\text{I}}_{\text{LMT}} \text{19,}$$
wherein is the preset current.

20. The system according to claim 11, wherein the controller is configured to limit the magnitude of the positive-sequence reactive current and limit the magnitude of the negative-sequence reactive current by setting I_{Q1}* and I_{Q2}* such that:. 20|I_{Q},*| ≤ I₃, | I_{Q2}* | ≤ I₄, wherein I_{Q1}* is a commanded value of the positive-sequence reactive current, and I_{Q2}* is a commanded value of the negative-sequence reactive current.
